(19) United States
(12) Patent Application Publication
(10) Pub. No.: US 2008/0079721 A1
(43) Pub. Date: Apr. 3, 2008

(54) Method for corresponding, evolving and tracking feature points in three-dimensional space

(75) Inventors: Fu-Jen Hsiao, Hsinchu (TW); Wen-Hao Wang, Hsinchu (TW); Tsu-Han Chen, Hsinchu (TW); Wen-De Zhang, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/889,590

(22) Filed: Aug. 15, 2007

(30) Foreign Application Priority Data
Sep. 29, 2006 (TW) 095136372

(51) Int. Cl. G06T 15/00

(52) U.S. Cl. 345/419; 348/E09.001

(57) ABSTRACT

A method for corresponding, evolving and tracking feature points in a three-dimensional space performs corresponding, evolving and tracking on the features points after transferring the two-dimensional feature point information in an image information into a corresponding state in the three-dimensional space. A recursion is employed to continuously update the states of the feature points in the three-dimensional space and evaluate the stability of the feature points by evolving. Hence, the obtained three-dimensional feature point information has a stronger corresponding relationship than the feature point information conventionally generated on the basis of the two-dimensional feature point information. As a result, a more precise three-dimensional scene can then be constructed.

### CROSS-REFERENCE TO RELATED APPLICATIONS

This non-provisional application claims priority under 35 U.S.C. § 119(a) on Patent Application No(s). 095136372 filed in Taiwan, R.O.C. on Sep. 29, 2006, the entire contents of which are hereby incorporated by reference.

### BACKGROUND OF THE INVENTION

1. Field of Invention

The present invention relates to a method for generating feature point information, and more particularly to a method for corresponding, evolving and tracking feature points in a three-dimensional space, so as to obtain three-dimension feature point corresponding information required for constructing a three-dimensional scene.

2. Related Arts

A three-dimensional scene is constructed mainly by continuously retrieving the feature point information from the image sequence. After recovering the projection geometry represented by the feature point information in an image corresponding manner, a three-dimensional scene can then be reconstructed. The reconstruction precision of the three-dimensional scene is mainly subject to the strong corresponding relationship among the feature point information which are obtained from the image sequence, wherein the strong corresponding relationship comes from whether the feature corresponding of different images are precisely determined or not. In other words, if the corresponding relationship between the reliable feature point information in successive two images is established, a precise reconstruction of three-dimensional scene can then be expected.

According to different practical requirements and situations, recently the technical field related to “technique for establishing the corresponding relationship between image features” can be categorized into three types. The first type is a technique developed for stereo image. The second type is a technique developed for images having large angle variance and long baseline. The last type is a technique developed for image sequences having small overall variance. The last type is the most commonly used technique for processing an image sequence (constituted by a series of image frames being continuous or discontinuous in time) shot by a handheld digital video camera, which can be applied to the prior art of processing “the establishment of the corresponding relationship between image features” of the similar image sequence. The technical content disclosed in the U. S. Patent No. U.S. Pat. No. 5,606,627 mentioned that according to two images with a known shooting state (i.e., the shooting parameters of the camera are known), the common features of points and edges of the two images are retrieved, and the three-dimensional space coordinates of the feature points are respectively estimated, and the three-dimensional scene is obtained by parallax estimation. This technique uses two-dimensional feature point information to update the feature point information, but the correctness of the feature corresponding relationship is not taken into consideration. However, U.S. Patent No. U.S. Pat. No. 5,946,041 mentioned a feature corresponding relationship established from image sequence in a two-dimensional space, wherein the features are found out in the first image, an operation of the corresponding process is performed in the second image, and then a correct feature corresponding process is established by correcting the estimated two-dimensional motion vector. In the technique, the correctness in the feature corresponding relationship is further taken into account and processed, and the feature point information is also updated based on the two-dimensional feature point information.

The aforementioned prior arts all belong to the technical content of “the establishment of the image feature corresponding relationship” totally based on the two-dimensional feature point information. The technical content includes the corresponding and tracking processes on the feature points, but has the following problems since the process information provided by the two-dimensional feature point information is limited.

(1) The robustness of the image feature corresponding relationship established by the two-dimensional feature point information is deficient.

(2) Errors tend to be generated while transferring from the two-dimensional feature point information into the three-dimensional scene.

Therefore, when the feature point information is used to reconstruct the three-dimensional scene, the accuracy of the three-dimensional scene will be deficient. This is an inherent problem in the process of corresponding and tracking the feature points using the two-dimensional feature point information. Further, errors are generated while transferring from the two-dimensional feature point information to the three-dimensional scene. As a result, a satisfied effect of the reconstructed three-dimensional scene cannot be achieved.

### SUMMARY OF THE INVENTION

In view of the above problems, the main object of the present invention is to provide a method for corresponding, evolving and tracking feature points in a three-dimensional space, which is performed by: (1) using the time series analysis technique to update and track the states of the feature points in three-dimensional space, and (2) using the feature evolving process to screen the feature points needed to be remained in the three-dimensional space according to the stability of the corresponding relationship of each feature point, and using a feature corresponding, evolving and tracking process in a recursive way to finally screen a feature point group having a strong corresponding relationship to output, so as to establish a three-dimensional scene with higher accuracy.

The method of the present invention is especially suitable for processing an image sequence captured by a handheld digital video camera. The feature points in successive two images may be visible or invisible due to the slight change in the shooting angle. Thus, besides the basic process of the two-dimensional feature point information, the corresponding, evolving and tracking must be performed through the states of the feature points in the three-dimensional space, so as to screen a feature point group having a strong corresponding relationship. The present invention is not only suitable for processing the image sequence comprising image frames discontinuous in time, but also can be directly applied in processing a group of spatial points having three-dimensional track or motion on the time axis.

Regarding the time series analysis technique used in the present invention, Kalman filter time series analysis model is adopted as one of the embodiments.

The present invention calculates the strength of the corresponding relationship of the feature points when they evolve with addition and deletion of the feature points. The initial state of the newly added feature point is initialized according to the distance from the neighboring feature points and the survival time thereof. In addition, deletion of a feature point is determined by calculating the error generated during the corresponding or updating process of the feature points.

The features and examples of the embodiments of the present invention are illustrated in detail with reference to the drawings below.

Broad scope of applicability of the present invention will become apparent from the detailed description given hereinafter. However, it should be noted that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The patent or application file contains at least one drawing executed in color. Copies of this patent or patent application publication with color drawing(s) will be provided by the office upon request and payment of the necessary fee.

They will be full comprehensibility of the present invention from the detailed description given herein below for illustration only, and thus are not limitative of the present invention, and wherein:

FIG. 1 is a schematic view of the general operation according to the present invention;

FIG. 2 is a schematic view of the operation of a time series analysis according to the present invention;

FIG. 3 is a flow chart of a method according to the present invention;

FIGS. 4A to 4E are schematic views of a feature point information evolving process according to the present invention;

FIG. 5A is a three-dimensional scene reestablished by feature point information generated by the conventional art; and

FIG. 5B is a three-dimensional scene reestablished by feature point information generated by the present invention.

### DETAILED DESCRIPTION OF THE INVENTION

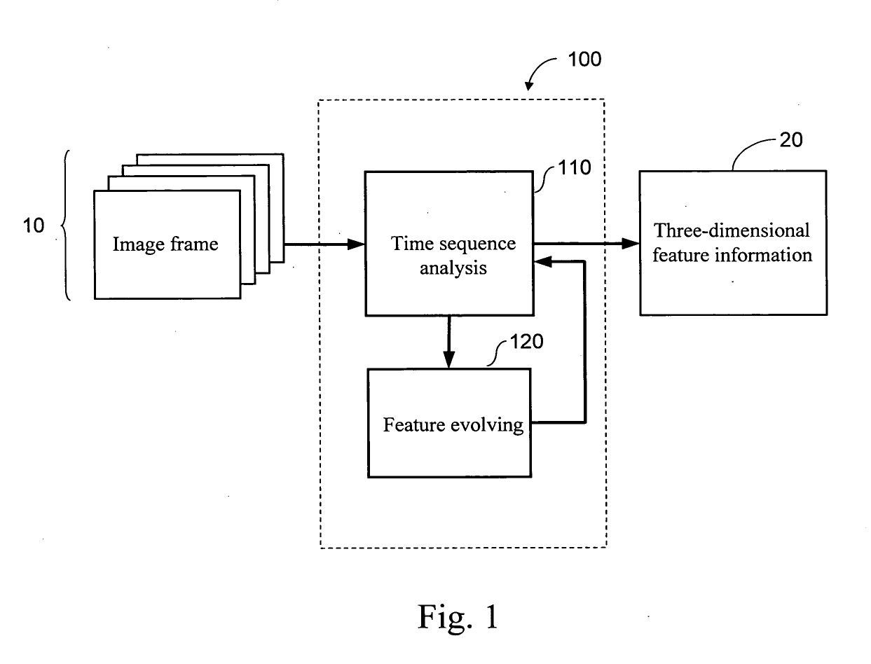

Referring to FIG. 1, a basic schematic view of a general operation of the present invention is shown. As shown in the figure, the present invention is implemented by two stages of process comprising a time series analysis 110 and a feature evolving 120. The method of the present invention is accomplished by executing a computer software program on a computer platform. As shown by the dashed line, the method is accomplished by a feature point information generating system 100 stored as the computer software program. The input data of the whole feature point information generating system 100 is an object. The object can be an image sequence 10 including a series of image frames being discontinuous in time or a group of space points having three-dimensional track or motion mode on the time axis, and the output data is three-dimensional feature point information 20 of the three-dimensional scene. The operating steps of the method of the present invention are illustrated on the premise that the object of the input data is the image sequence 10, and the difference in the operating steps caused by the difference in the input data will be given later on.

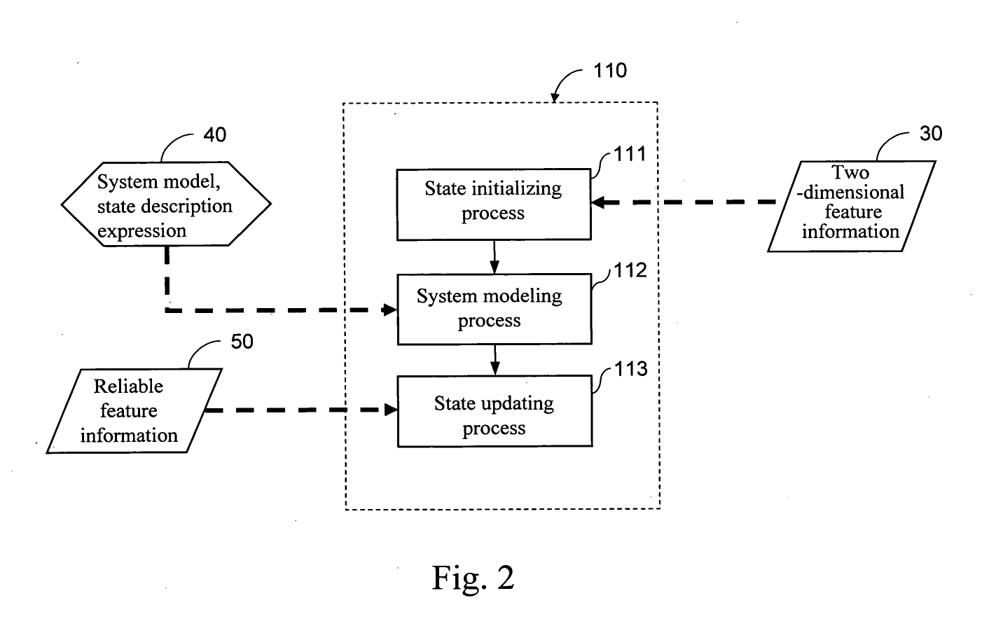

FIG. 2 is a schematic view of the operation of the time series analysis 110 in the method according to the present invention. The time series analysis 110 mainly comprises three processes, namely state initializing process 111, system modeling 112 and state updating process 113. The state initializing process 111 is responsible for initializing the feature point information of the input object (e.g., the image sequence 10) on each time point, and determining the feature point information 30 (including the feature point and the three-dimensional state) of the image frame at the time point. Taking the image sequence 10 as an example, after being initialized, the feature point information of the first image frame in the input image sequence 10 will become feature point information including the feature point group and the three-dimensional state collection corresponding to the feature point group. The system modeling 112 is responsible for establishing an appropriate analysis model to match with the input object (i.e., the image sequence 10), which includes a system model and a state description expression (as shown in the part marked with 40). This part is set by the data input from outside according to motion mode or other attributes of the practically input image sequence 10, and also can be properly adjusted according to the motion mode or other attributes of different input objects. After the initialization is accomplished by the above steps, the input image sequence 10 is illustrated through the analysis model in the system modeling program 112 according to the property during shooting. Finally, the state updating process 113 is used to update the state of each feature point. This part operates together with the part of feature evolving process 120 in FIG. 1, wherein the feature point information of each image frame after being initialized and described by the analysis model is transferred into the feature evolving process 120 for screening the feature points, and then the feature point information are updated according to the screening result (i.e., the reliable feature point information 50), until the process on all input image frames is finished, and finally the feature point group having a strong corresponding relation is remained for being used for reconstructing an accurate three-dimensional scene. In the stage of feature evolving 120, it must be emphasized that the screening (appearing or disappearing) of the feature points is a process like the biologic evolving, wherein the three-dimensional state of the feature points passes down in a recursion means process, thus being different from a simple screening good from bad.

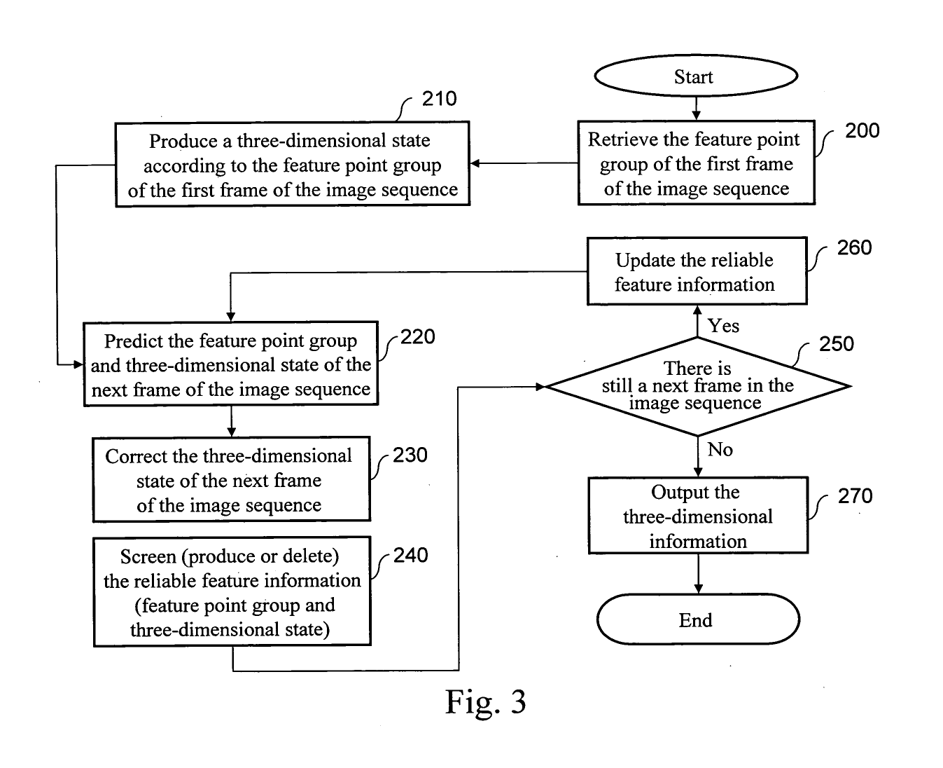

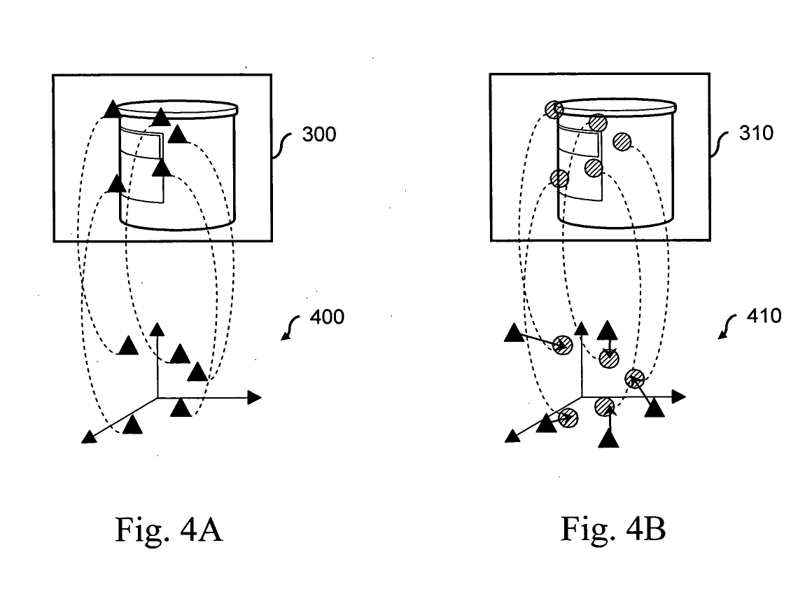

The detailed method flow is illustrated with reference to FIGS. 3 and 4A to 4E, which is illustrated on the premise that the input object is the image sequence 10.

First, when each image frame in the image sequence 10 is input according to the time point, the part of the time series analysis 110 executes the processes described in FIG. 2, and the analysis model adopted in the time series analysis is mainly the Kalman Filter time series analysis model:

(1) The state initializing process 110 mainly includes two situations. The first executing situation of the initializing process is executed as that, when a first image frame is input, i.e., when time t=0, the initializing process directly generates a feature point group {Y₀} of the first image frame (Step 200), and generates a three-dimensional state collection {X₀} corresponding to the feature point group (Step 210) as the feature point information thereof. As shown by the triangular pattern in FIG. 4, a three-dimensional state collection {X₀} 400 corresponding to the time t=0 is directly generated by the feature point group {Y₀} 300 of the first image frame at the time t−0.

{X₀} is obtained by initializing three-dimensional states on each feature point y₀ of the {Y₀} through the Kalman Filter time series analysis model. The three-dimensional state x₀ includes the horizontal position, vertical position and depth position of the feature point in the three-dimensional space. The depth position can be generated by first computing {Y₀} and {Y₁} through the three-dimensional vision manner, and then projecting through a camera model. {Y₁} is obtained by finding corresponding point {Y₀} in the first image frame.

Another situation of the initializing process is executed as that, when the image frame is input not for the first time (i.e., when the input image frame is not the first image frame), i.e., the image frame input at the time t, since the reliable feature point information 50 (i.e., the feature point information including the feature point group and the three-dimensional state collection) remained after the operation of the former image frame is updated into the feature point information of the former image frame, the next input image frame takes the updated feature point information as the initialization result (Step 260). This situation is shown as the triangular pattern in FIG. 4B.

(2) After the state initializing process is finished, the feature point information of the image frame being processed is transferred into the system modeling 112 for predicting the state, and the predicting of the feature point information ({Yₜ₊₁}, {xₜ₊₁}) of the initialized feature point information {Yₜ} and the three-dimensional state {xₜ} at the next time point is performed through the established analysis model (Step 220). As described above, the analysis model used in the embodiment of the present invention is the Kalman Filter time series analysis model, wherein the descriptions on Yₜ and Xₜ are represented by the following expressions:

Xₜ₊₁=FₜXₜ+Uₜ+Qₜ;

Yₜ=HₜXₜ+Rₜ;

Fₜ simulates the linear variation process of the state Xₜ along with the time, Uₜ is a known translation amount at the state of Xₜ, Hₜ simulates the relationship between Xₜ and Yₜ, Qₜ and Rₜ simulate the interference of noise, wherein Qₜ also can be represented as Qₜ˜N(0, qₜ), Rₜ also can be represented as Rₜ˜N (0, rₜ). Therefore, the prediction value of each Xₜ₊₁ is represented as

$${X}_{\overline{t + 1}} ∼ N ( {\hat{X}}_{\overline{t + 1}} , {P}_{\overline{t + 1}} ) ,$$

wherein

$${\hat{X}}_{\overline{t + 1}} = {F}_{t} {\hat{X}}_{t} + {U}_{t} , {P}_{\overline{t + 1}} = {F}_{t} {P}_{t} {F}_{t}^{T} + {Q}_{t} .$$

### The part of yₜ₊₁ can be obtained from each yₜ in {Yₜ} through a feature matching method.

As shown in FIG. 4B, the circular pattern shown in the upper portion is a predicted feature point group {Yₜ₊₁} 310 at the time t+1, and the triangular pattern shown in the lower portion is the predicted three-dimensional state collection {Xₜ₊₁} 410.

(3) After the state is predicted, the three-dimensional state collection {Xₜ₊₁} in the prediction result must be properly corrected (Step 230). The above can be mainly achieved by the correcting model existing in the Kalman Filter time series analysis model, and the correcting model is represented by the following expression.

Xₜ₊₁˜N(\hat{X}ₜ₊₁, Pₜ₊₁);

wherein

$${\hat{X}}_{t + 1} = {\hat{X}}_{\overline{t} + 1} + {K}_{t + 1} {E}_{t + 1} , {P}_{t + 1} = ( I - {K}_{t + 1} {H}_{t + 1} ) {P}_{\overline{t + 1}} .$$

In the Kalman Filter time series analysis model, the error E and gain K are

respectively defined as Eₜ₊₁=(Yₜ₊₁−Hₜ₊₁\hat{X}ₜ₊₁) and

$${K}_{t + 1} = \frac{{P}_{t ∓ 1} {H}_{t + 1}^{T}}{{H}_{t + 1} {P}_{t ∓ 1} {H}_{t + 1}^{T} + {R}_{t + 1}} .$$

### Therefore, after the process, a shift is generated on the prediction, and the three-dimensional state collection is corrected as {\hat{X}ₜ₊₁}, and is reset as {Xₜ₊₁}.

As shown in FIG. 4B, the circular pattern shown in the lower portion is the predicted three-dimensional state collection {Xₜ₊₁} generated after being corrected at the time t+1, with the position being corrected from the triangular pattern shown in the lower portion before being corrected to the position of the circular pattern. It includes predicted feature point group {Yₜ₊₁} 310 at the time t+1 and the predicted three-dimensional state collection {Xₜ₊₁} 410 at the time t+1.

The above correcting model can be properly adjusted according to the employed analysis model, and further can be properly adjusted according to the motion mode of the input image sequence 10 in the three-dimensional space. The related adjusting method differs according to the different analysis models, but the present invention holds the design flexibility of the adjustment of this part.

(4) The corrected feature point information ({Yₜ₊₁}, {Xₜ₊₁}) is transferred from the time series analysis 110 stage to the feature evolving 120 stage. In this stage, the reliable feature point information ({\tilde{Y}ₜ₊₁}, {\tilde{X}ₜ₊₁}) to be remained is screened by the evolving operation on the feature points (Step 240), which mainly includes two parts of screening given below in detail.

The first part is generating a new feature point, which includes the following steps.

(a) The new feature point is found out according to the method of corresponding the feature points between {Yₜ} and {Yₜ₊₁}, and added into {\tilde{Y}ₜ₊₁}.

(b) A weight

$${w}_{{x}_{t + 1}^{′}}$$

is set for initializing the three-dimensional state collection of the collection {\tilde{X}ₜ₊₁}, wherein the weight is determined by the state value of the neighboring feature points. The weight value is represented by the existing time of neighboring feature points in the whole image sequence 10, or represented by the distance from the neighboring feature points.

The definition of the neighboring feature points is represented by the following expression:

X′ₜ₊₁={xₜ₊₁εXₜ₊₁|∥yₜ₊₁−\tilde{y}ₜ₊₁∥<η};

And, the expression of the weight

$${w}_{{x}_{t + 1}^{′}}$$

is:

$${w}_{{x}_{t + 1}^{′}} = \frac{Age ( {x}_{t + 1}^{′} )}{‖ {y}_{t + 1}^{′} - {\tilde{y}}_{t + 1} ‖ {\sum }_{i = t + 1 - Age ( {x}_{t + 1}^{′} )}^{t + 1} {α}_{t + 1 - i} {\vert {E}_{i} ( {x}_{i}^{′} ) \vert}^{2}} ;$$

Therefore, the three-dimensional state of each x,+, after being initialized can be further represented by the following expression:

$${\tilde{x}}_{t + 1} = \frac{{\sum }_{{x}_{t + 1}^{′} ∈ {X}_{t + 1}^{′}} {w}_{{x}_{t + 1}^{′}} {x}_{t + 1}^{′} + β {X}_{0}}{{\sum }_{{x}_{t + 1}^{′} ∈ {X}_{t + 1}^{′}} {w}_{{x}_{t + 1}^{′}}} .$$

After the process of generating the new feature point, the feature point information is shown by the hollow circular pattern connected by dashed line in FIG. 4C, which includes the newly added feature point group {\tilde{Y}ₜ₊₁} 320 at the time t+1 and the newly added three-dimensional state collection {\tilde{X}ₜ₊₁} 420 at the time t+1.

The second part is deleting the feature point, which includes the following steps.

(c) The feature point generating an error larger than the threshold during the feature matching process is deleted from the existing feature point collection {\tilde{Y}ₜ₊₁}. This part may generate errors in the feature matching process when the feature point is found out by the feature matching method, thus the feature points with large errors must be deleted.

(c) The feature point generating an error larger than the threshold during the feature corresponding is deleted from the newly generated feature point collection {\tilde{Y}ₜ₊₁}. This part is the same as the former process, which is used to delete the feature points generated by the feature matching error.

(c) and (d) mainly define Pₜ( [symbol] ) as a rectangular region taking [symbol] as the center at the time t, and thus at the time t+1, the feature matching error Eₜ₊₁(yₜ, yₜ₊₁) of each feature point yₜ₊₁ in the existing feature point collection {Yₜ₊₁} is defined as the following expression:

Eₜ₊₁(yₜ, yₜ₊₁)=∥Pₜ(yₜ)−Pₜ₊₁(yₜ₊₁)∥;

and the feature corresponding error Eₜ₊₁(\tilde{y}ₜ, \tilde{y}ₜ₊₁) of each feature point \tilde{y}ₜ₊₁, in the newly generated feature point collection {\tilde{Y}ₜ₊₁} is defined as the following expression:

Eₜ₊₁(\tilde{y}ₜ₊₁, \tilde{y}ₜ)=∥Pₜ₊₁(\tilde{y}ₜ₊₁)−Pₜ(\tilde{y}ₜ)∥;

and when Eₜ₊₁(yₜ, yₜ₊₁) and Eₜ₊₁(\tilde{y}ₜ₊₁, \tilde{y}ₜ) are respectively larger than the preset threshold, the feature points yₜ₊₁ and \tilde{y}ₜ₊₁ are deleted.

(e) The feature point with an error calculated by the system model analysis during the prediction of {Xₜ₊₁} larger than the threshold is to be deleted. This part is mainly directed to delete the feature point with large error when the three-dimensional state is transferred through the Kalman Filter time series analysis model.

The error is defined as the difference between the state \hat{X}ₜ₊₁ (obtained by correcting each xₜ₊₁ in the collection {Xₜ₊₁} through the Kalman Filter time series analysis model) multiplying Hₜ₊₁ and each y₁ in the feature point collection {Yₜ}, which can be represented as

$${E}_{t + 1} ( {y}_{t} , {y}_{t + 1} ) = ( {Y}_{t + 1} - {H}_{t + 1} {\hat{X}}_{t + 1}^{-} ) .$$

### Likewise, when the error exceeds the preset threshold, the corresponding feature point is deleted.

After the feature point is deleted, the deleted feature point information is represented by connecting the part marked with “X” by dashed lines, and the survival feature point includes the feature point group {\tilde{Y}ₜ₊₁} 330 after the deletion at the time t+1 and the three-dimensional state collection {\tilde{X}ₜ₊₁} 430 after the deletion at the time t+.

After the Step 240, the generated feature point information ({\tilde{Y}ₜ₊₁}, {\tilde{X}ₜ₊₁}) is the so-called reliable feature point information, and the feature point groups in the feature point information all have a strong corresponding relationship. At this point, whether other images in the image sequence 10 still need to be processed or not is determined (Step 250). If yes, it is necessary to return to the Step 220 to execute in a recursion manner, however, before that, the step 260 of transferring the newly obtained reliable feature point information back to the stage of time series analysis 110 for being updated must be performed. That is, during the state updating process 113, {Yₜ₊₁}={Yₜ₊₁}+{\tilde{Y}ₜ₊₁} and {Xₜ₊₁}={Xₜ₊₁}+{\tilde{X}ₜ₊₁} are taken as the state ({Yₜ₊₁},{Xₜ₊₁}) of the reliable feature point information 50 when a next image frame in the image sequence 10 is processed.

Now the reliable feature point information 50 ({Yₜ₊₁},{Xₜ₊₁}) is the triangular pattern connected by dashed lines as in FIG. 4E, which includes the updated feature point group {Yₜ₊₁} 340 at the time t+1 and updated three-dimensional state collection {Xₜ₊₁} 440 at the time t+1.

On the contrary, if all the image frames in the image sequence 10 are processed, the finally remained reliable feature point information 50 (i.e., the so-called three-dimensional feature point information) is output to the state updating process 113 (Step 270), and the {Yₜ₊₁}={Yₜ₊₁}+{\tilde{Y}ₜ₊₁} and {Xₜ₊₁}={Xₜ₊₁}+{\tilde{X}ₜ₊₁} are taken as the final three-dimensional scene information of the whole image sequence 10.

As mentioned before, the input object is a group of space points having three-dimensional track or motion on the time axis. Since the space point itself has the content of the three-dimensional feature point information, when the above-mentioned state initializing process 111 executes the first situation of the initializing process, the process of generating three-dimensional state collection (i.e., the part of Step 210) executed when the first space point is input can be omitted.

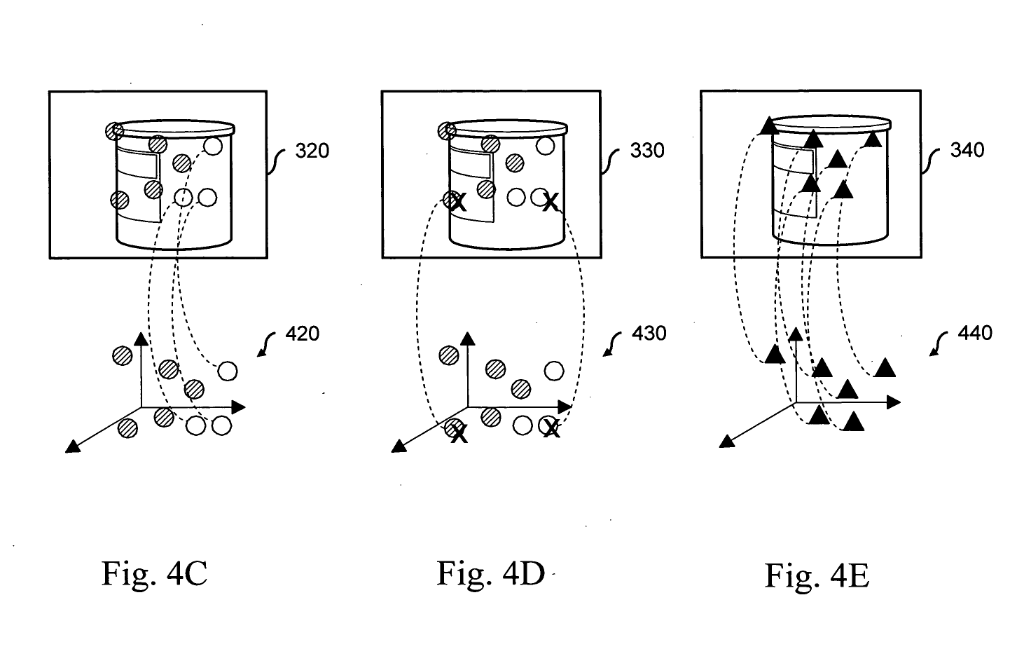

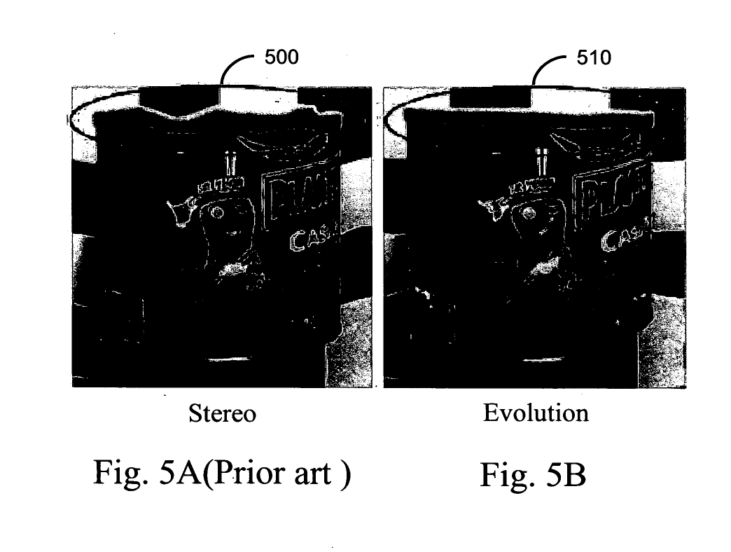

The reconstruction result of-the three-dimensional scene will become more accurate by means of the operation of the present invention-as demonstrated in the comparison between FIG. 5A and FIG. 5B. FIG. 5A is a three-dimensional scene established according to the feature point information generated by the conventional methods, and FIG. 5B is a three-dimensional scene reconstructed according to the feature point information generated by the technique of the present invention. It can be known from the marks (500 and 510) made in FIGS. 5A and 5B, the three-dimensional scene 510 generated according to the present invention has a much higher accuracy than the three-dimensional scene 500 reconstructed according to the conventional art. It is noted that at the position of the marks, the conventional methods tend to generate the feature point corresponding error resulting in the mistake of the three-dimensional scene information, so that an abnormal mapping phenomenon (e.g., the concavo-convex part of the mark 500) is generated on the texture mapping model. Since the present invention uses the time series analysis 110 to process and analyze the feature point information, the feature point information having a strong corresponding relationship is established by the present invention through initializing, predicting and correcting the feature point information. In addition, the present invention screens the feature point information continuously through the feature evolving 120, such that the finally obtained feature point information has a stronger corresponding relationship, and the generated three-dimensional scene has a higher accuracy than before.

With the descriptions of invention, it will be obvious that the same may be varied in many ways. Such variations are not to be regarded as a departure from the principle and scope of the invention, and all such modifications as would be obvious to one skilled in the art are intended to be included within the scope of the following claims.

What is claimed is:

1. A method for corresponding, evolving and tracking feature points in a three-dimensional space, comprising the steps of:
(a) initializing feature point information ({Yₜ}, {Xₜ}) of an object at a time t, wherein {Yₜ} represents a two-dimensional feature point group of the object, and {Xₜ} represents a three-dimensional state collection of each feature point in {Yₜ} of the object,
(b) establishing an analysis model, for using the feature point information {Yₜ} and {Xₜ} at the time t to predict feature point information ({Yₜ₊₁},{Xₜ₊₁}) of the object at a next time t+1;
(c) correcting the three-dimensional state collection of the object at the time t+1 into {\hat{X}ₜ₊₁} through a correcting model; and
(d) executing a state updating process for re-screening the feature point information ({\tilde{Y}ₜ₊₁}, {\tilde{X}ₜ₊₁}) of the object;
wherein, when the object is determined to be present at a next time, the feature point information ({Yₜ}, {Xₜ}) is updated, wherein {Yₜ₊₁}={Yₜ₊₁}+{\tilde{Y}ₜ₊₁} and {Xₜ₊₁}={Xₜ₊₁}+{\tilde{X}ₜ₊₁}, and the steps (b)-(d) are carried on.

2. The method for corresponding, evolving and tracking feature points in a three-dimensional space as claimed in claim 1, further comprising a step of outputting {Yₜ₊₁}={Yₜ₊₁}+{\tilde{Y}ₜ₊₁} and {Xₜ₊₁}={Xₜ₊₁}+{\tilde{X}ₜ₊₁} when the object is determined not to be present at the next time.

3. The method for corresponding, evolving and tracking feature points in a three-dimensional space as claimed in claim 1, further comprising a step of inputting at least an image frame as the object in an image sequence.

4. The method for corresponding, evolving and tracking feature points in a three-dimensional space as claimed in claim 1, wherein the step (a) further comprises a state initializing process step of directly retrieving the feature point group {Y₀} of the first image frame at the time t=0 and generating a corresponding three-dimensional state collection {xₒ}.

5. The method for corresponding, evolving and tracking feature points in a three-dimensional space as claimed in claim 4, wherein the three-dimensional state collection {xₒ} comprises a three-dimensional state collection of a horizontal position, a vertical position and a depth position of the each corresponding feature point in the three-dimensional space.

6. The method for corresponding, evolving and tracking feature points in a three-dimensional space as claimed in claim 5, wherein the estimation of the depth position further comprises a step of determining {Y₀} and {Yₜ} through a three-dimensional vision manner and then projecting through a camera model.

7. The method for corresponding, evolving and tracking feature points in a three-dimensional space as claimed in claim 6, further comprising a step of generating {Yₜ} through {Y₀} in a feature corresponding manner.

8. The method for corresponding, evolving and tracking feature points in a three-dimensional space as claimed in claim 1, further comprising a step of inputting a group of space points having three-dimensional track or motion mode on the time axis as the object.

9. The method for corresponding, evolving and tracking feature points in a three-dimensional space as claimed in claim 1, wherein the step (b) further comprises a system modeling process step of inputting a system model and a state description expression as the analysis model.

10. The method for corresponding, evolving and tracking feature points in a three-dimensional space as claimed in claim 9, wherein the analysis model is a Kalman filter time series analysis model.

11. The method for corresponding, evolving and tracking feature points in a three-dimensional space as claimed in claim 1, wherein the analysis model used in step (b) is taken into account by the correcting model to adjust the correcting model.

12. The method for corresponding, evolving and tracking feature points in a three-dimensional space as claimed in claim 11, wherein the correcting model is adjusted according to one motion mode of the object in the three-dimensional space.

13. The method for corresponding, evolving and tracking feature points in a three-dimensional space as claimed in claim 1, wherein the step (d) further comprises:
(d1) finding out a new feature point by corresponding {Yₜ} and {Yₜ₊₁} and adding into {\tilde{Y}ₜ₊₁}; and
(d2) setting a weight, for updating the three-dimensional state collection of {\tilde{X}₁₊₁}, wherein the weight is determined by a state value of neighboring feature points.

14. The method for corresponding, evolving and tracking feature points in a three-dimensional space as claimed in claim 13, wherein the weight in the step (d2) is determined by the state value of a feature point survival time of the neighboring feature points.

15. The method for corresponding, evolving and tracking feature points in a three-dimensional space as claimed in claim 13, wherein the weight in the step (d2) is determined by the state value of a distance from the neighboring feature points.

16. The method for corresponding, evolving and tracking feature points in a three-dimensional space as claimed in claim 13, wherein the step (d) further comprises:
(d3) setting a threshold;
(d4) deleting the feature point generating an error larger than the threshold during the feature corresponding from {Yₜ₊₁};
(d4) deleting the feature point generating an error larger than the threshold during the feature corresponding from {\tilde{Y}ₜ₊₁}; and
(d6) calculating the feature point generating an error resulting from the system model analysis larger than the threshold during the prediction of {Xₜ₊₁ } and deleting the feature point.
